(19) United States
(12) Patent Application Publication
(10) Pub. No.: US 2004/0233282 A1
(43) Pub. Date: Nov. 25, 2004

(54) Systems, apparatus, and methods for surveillance of an area

(76) Inventors: Donald J. Stavely, Windsor, CO (US); Norman Conrad Pyle, Greeley, CO (US); Miles Kevin Thorland, Fort Collins, CO (US); Daniel Joseph Byrne, Fort Collins, CO (US); Amol Subhash Pandit, Greeley, CO (US); Jeffrey Brian Beemer, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/443,417

(22) Filed: May 22, 2003

(51) Int. Cl. H04N 7/18

(52) U.S. Cl. 348/143; 348/152; 348/154; 348/155

(57) ABSTRACT

Disclosed are systems and methods for facilitating surveillance of an area. In one embodiment, a system and a method comprise capturing images of the area under surveillance using a portable digital camera, detecting motion occurring within the area under surveillance, and storing images of the area under surveillance captured by the digital camera.

### BACKGROUND

Growing interest in the security of one's home and safety of one's family has prompted the appearance of many surveillance systems in the market. These systems can be costly. Specifically, the consumer may need to pay for the system hardware and, often more significantly, for any required service that is provided by the security service provider.

Although such surveillance serves an important function, it would be desirable to have systems and methods for surveillance of an area that are less expensive and/or do not require a supporting service.

### SUMMARY OF THE DISCLOSURE

Disclosed are systems, apparatus, and methods for facilitating surveillance of an area. In one embodiment, a system and a method comprise capturing images of the area under surveillance using a portable digital camera, detecting motion occurring within the area under surveillance, and storing images of the area under surveillance captured by the digital camera.

### BRIEF DESCRIPTION OF THE DRAWINGS

The disclosed systems, apparatus, and methods can be better understood with reference to the following drawings. The components in the drawings are not necessarily to scale.

FIG. 1 is a schematic view of an embodiment of a system that facilitates surveillance of an area.

FIG. 2 is a block diagram of an embodiment of a camera shown in FIG. 1.

FIG. 3 is a block diagram of an embodiment of a user computing device shown in FIG. 1.

FIG. 4 is a flow diagram that illustrates an embodiment of a method for conducting surveillance on an area.

FIGS. 5A-5C comprise a flow diagram that illustrates an embodiment of operation of a surveillance system of the user computing device shown in FIG. 3.

FIGS. 6A and 6B comprise a flow diagram that illustrates a first embodiment of operation of a camera surveillance module of the camera shown in FIG. 2.

FIGS. 7A and 7B comprise a flow diagram that illustrates a second embodiment of operation of a camera surveillance module of the camera shown in FIG. 2.

### DETAILED DESCRIPTION

Disclosed herein are embodiments of systems, apparatus, and methods that provide surveillance of an area. Although particular embodiments are disclosed, these embodiments are provided for purposes of example only to facilitate description of the disclosed systems, apparatus, and methods. Accordingly, other embodiments are possible.

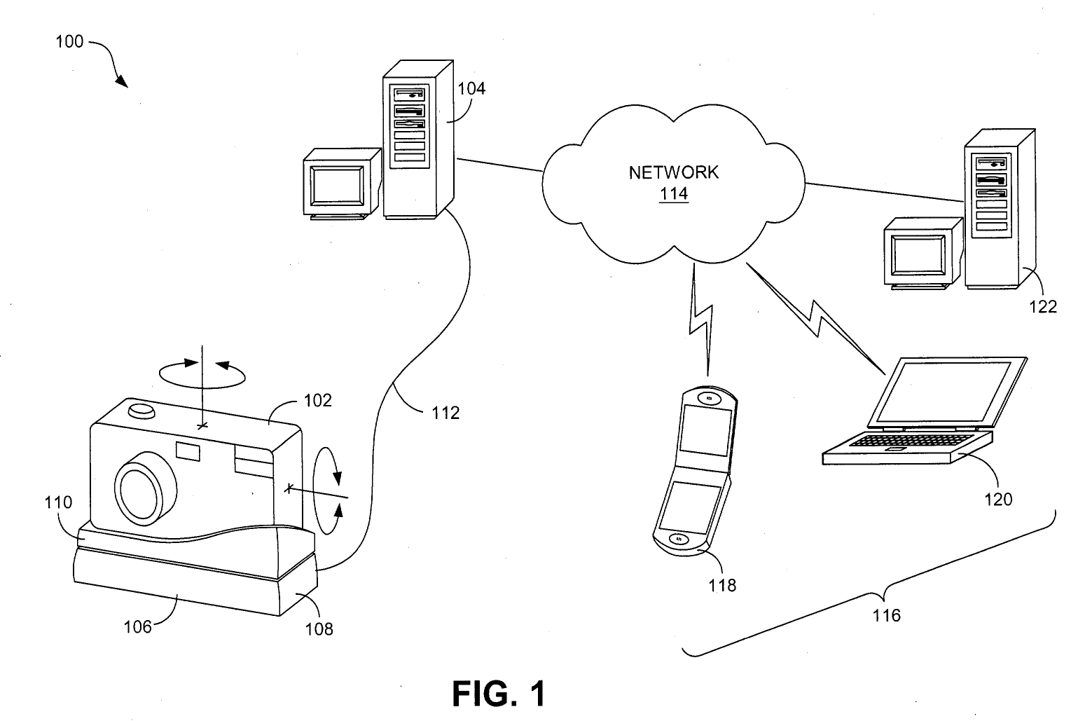

Referring now to the drawings, in which like numerals indicate corresponding parts throughout the several views, FIG. 1 illustrates a system 100 that provides surveillance of an area, such as a room in one's home or in one's office. As indicated in this figure, the example system 100 comprises a digital camera 102 that is used to capture images of the environment in which surveillance is conducted, and a user computing device 104 that communicates with the camera via a camera docking station 106. The digital camera 102 comprises a portable, consumer digital camera of the type often used to take snapshots of friends, family, and places visited (e.g., a “point and shoot” camera).

The camera docking station 106 comprises an interface (not visible in FIG. 1) with which the digital camera 102 electrically connects to the docking station such that communications received by the docking station from the user computing device 104 can be delivered to the camera. In alternative embodiments, however, the camera 102 may directly communicate (either using a cable or a wireless transceiver) with the computing device 104. Regardless, the camera docking station 106 supports the camera 102 so that its lens may be directed at an area to be observed. Optionally, the docking station 106 is configured to pan and/or tilt the camera 102 (as indicated with double-headed arrows) when necessary or desired. In such a case, the docking station 106 may comprise a base 108 and a manipulable platform 110 upon which the camera 102 rests (i.e., docks). When the docking station 106 is configured to pan and/or tilt, it further includes one or more motors and actuators (not shown) that are used to rotate and tilt the platform in response to commands received by the computing device 104 and/or the camera 102.

As is further depicted in FIG. 1, the docking station 106 connects to the user computing device 104 using a cable 112, such as a universal serial bus (USB) cable. In other embodiments, however, the docking station 106 comprises a wireless transceiver (not shown) that supports wireless (e.g., radio frequency (RF)) communications with the computing device 104. The computing device 104 typically is located on the premises in which surveillance is to be conducted and may comprise a personal computer (PC) such as that shown in FIG. 1. Other computing devices having relatively large computing and/or storage capacity or that facilitate data transmission may be used. As is discussed in greater detail below, the computing device 104 may be omitted from the system 100 altogether in embodiments in which the camera 102 (or the camera and its docking station 106) alone is used to provide the surveillance.

As is further indicated in FIG. 1, the user computing device 104 is connected to a network 114 with which the computing device may transmit data to other devices 116. When the computing device 104 is not used in the system 100, the camera 102 and/or its docking station 106 may be connected to this network 114. In the embodiment shown in FIG. 1, the other devices 116 comprise a mobile phone and/or personal digital assistant (PDA) 118, a notebook computer 120, and a server computer 122. By way of example, the mobile phone/PDA 118 and notebook computer 120 may be operated by the consumer (i.e., “user”) when away from the premises at which the surveillance takes place, and the server computer 122 may be a computer operated by or on the behalf of a security company or law enforcement organization (e.g., police department). With the connection between the camera 102 (e.g., via the user computing device 104) and the other devices 116, images captured by the camera and/or intruder alerts may be forwarded to the user while away from the premises under surveillance, to the security company, to the law enforcement organization, or to a designated party or system.

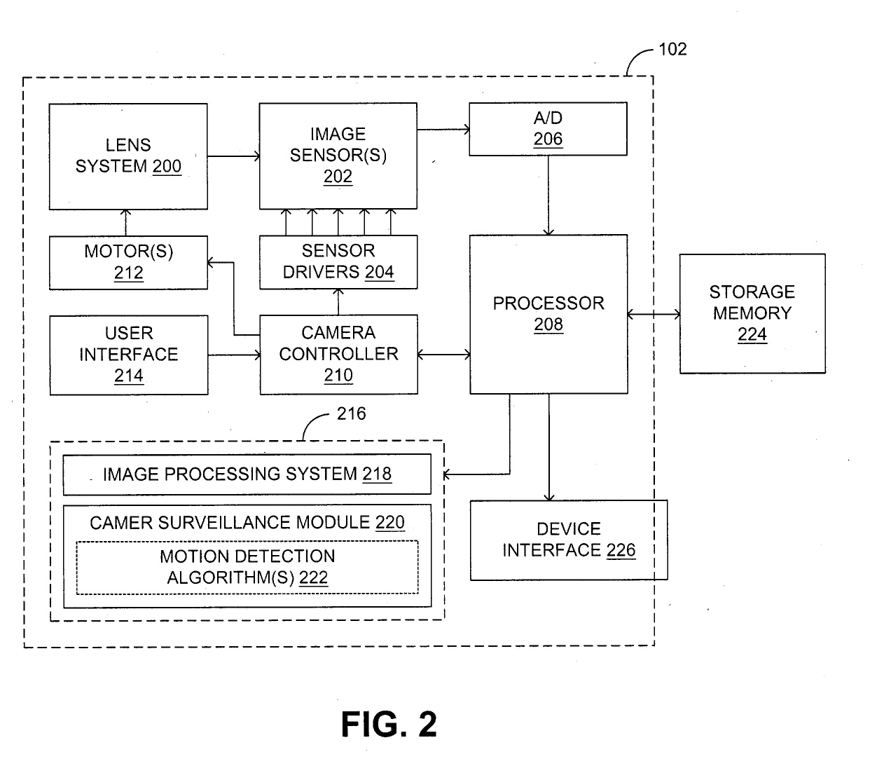

FIG. 2 illustrates an embodiment of the camera 102 used in the system 100 of FIG. 1. In this embodiment, the camera 102 is a digital still camera. Although a digital still camera implementation is shown in FIGS. 1 and 2 and described herein, the camera 102 more generally comprises any device that can capture digital images. Accordingly, the camera 102 could instead comprise a digital video camera that captures multiple images that are played in sequence to create video footage.

As indicated in FIG. 2, the camera 102 includes a lens system 200 that conveys images of viewed scenes to an image sensor 202. By way of example, the image sensor 202 comprises a charge-coupled device (CCD) or a complementary metal oxide semiconductor (CMOS) sensor that is driven by one or more sensor drivers 204. The analog image signals captured by the sensor 202 are provided to an analog-to-digital (A/D) converter 206 for conversion into binary code that can be processed by a processor 208.

Operation of the sensor driver(s) 204 is controlled through a camera controller 210 that is in bi-directional communication with the processor 208. The controller 210 also controls one or more motors 212 that are used to drive the lens system 200 (e.g., to adjust focus and zoom). Operation of the camera controller 210 may be adjusted through manipulation of the user interface 214. The user interface 214 comprises the various components used to enter selections and commands into the camera 102 and therefore can include a shutter-release button and various control buttons.

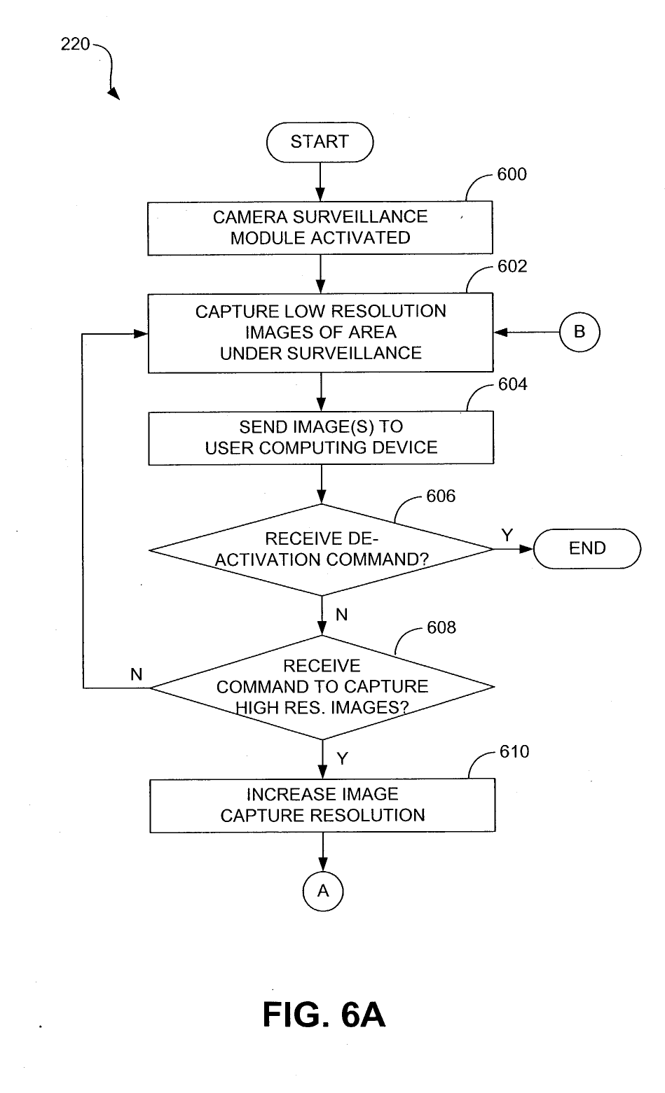

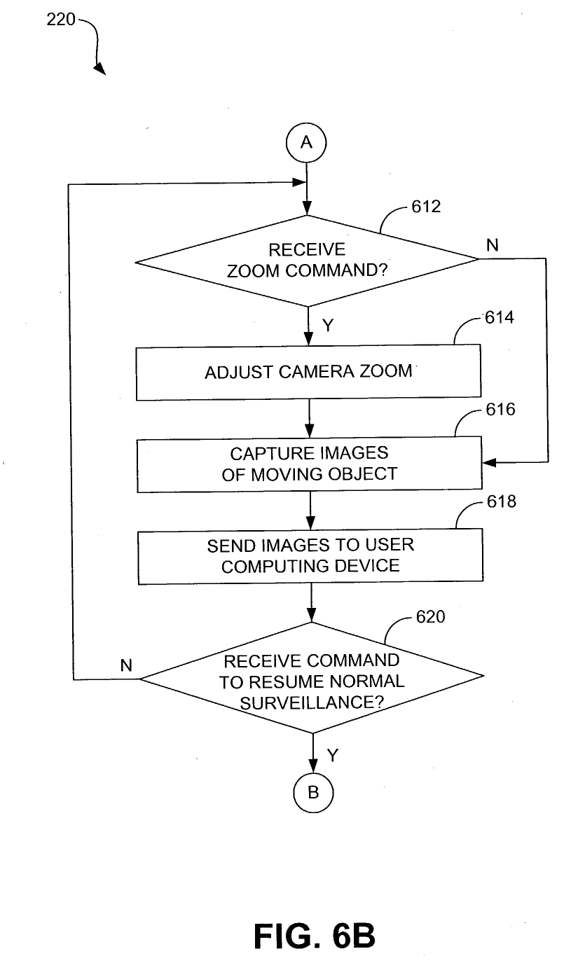

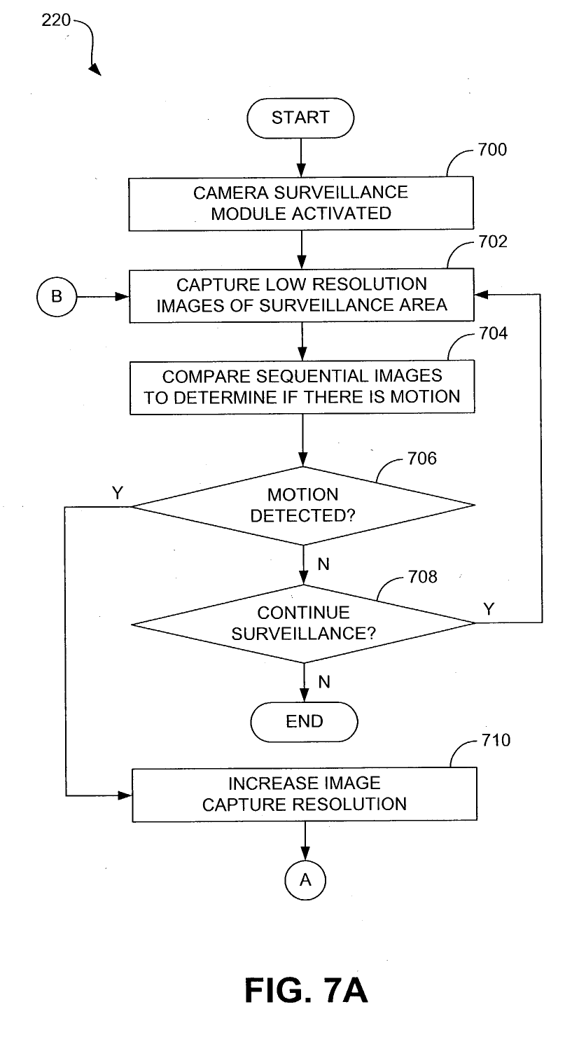

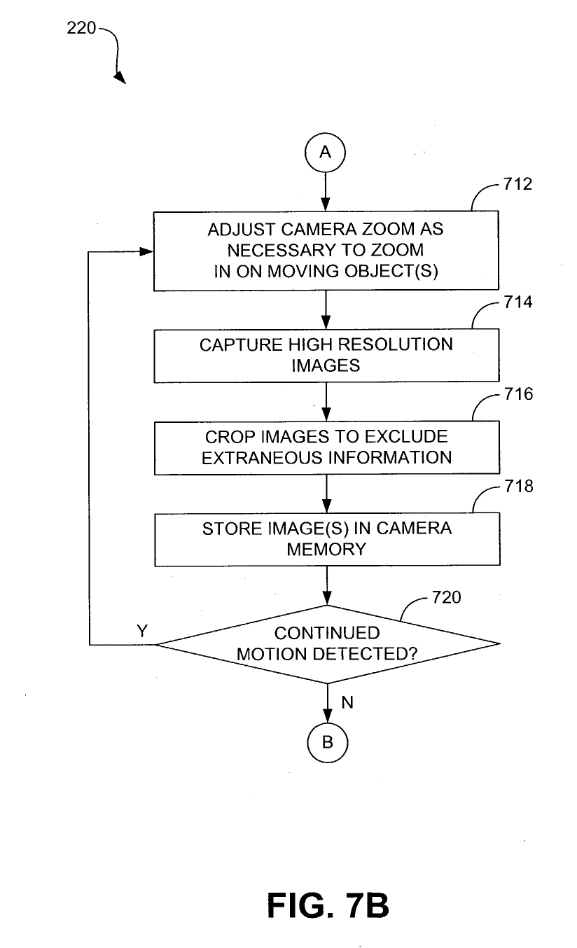

The digital image signals are processed in accordance with instructions from an image processing system 218 stored in permanent (non-volatile) device memory 216. Processed (e.g., compressed) images may then be stored in storage memory 224, such as that contained within a removable solid-state memory card (e.g., Flash memory card). In addition to the image processing system 218, the device memory 216 further comprises a camera surveillance module 220. The nature of the camera surveillance module 220 depends upon the mode in which it operates. More specifically, the camera surveillance module 220 may act in a relatively passive manner and simply execute commands received from another device (e.g., the user computing device 104), or may act in a more active manner in which it controls surveillance to a significant degree. In the latter case, the surveillance module 220 may comprise one or more motion detection algorithms 222 that are configured to analyze captured images to determine whether an object is moving within the area under surveillance. Examples of operation of the camera surveillance module 220 in each case are provided below in relation to FIGS. 6-7.

The camera embodiment shown in FIG. 2 further includes a device interface 226, such as a universal serial bus (USB) connector, that is used to connect to another device, such as the camera docking station 106 and/or the user computing device 104.

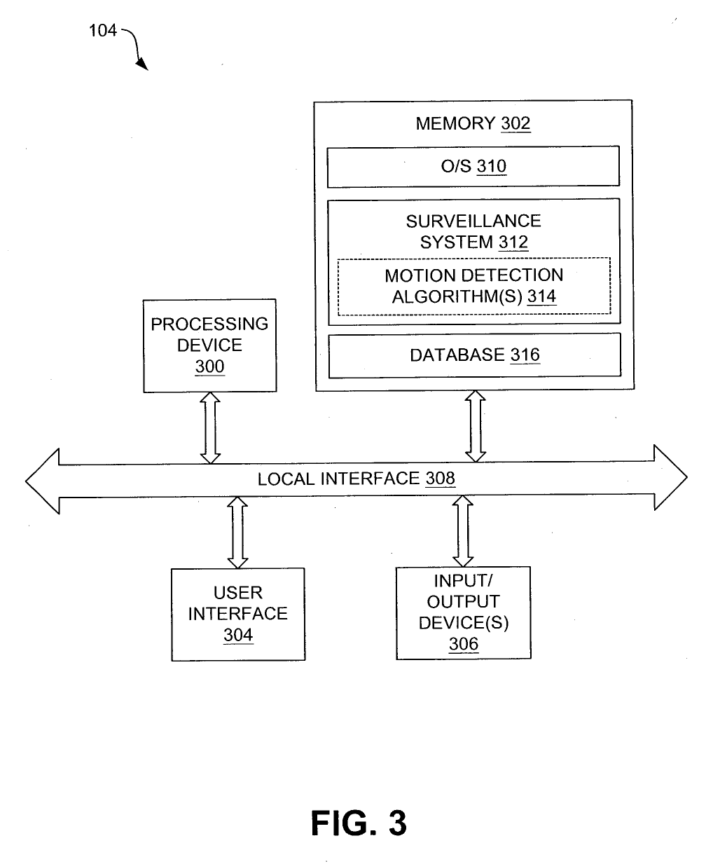

FIG. 3 illustrates an embodiment of the user computing device 104 shown in FIG. 1. As indicated in FIG. 3, the computing device 104 comprises a processing device 300, memory 302, a user interface 304, and at least one input/output (I/O) device 306, each of which is connected to a local interface 308.

The processing device 300 can include a central processing unit (CPU) or an auxiliary processor among several processors associated with the computing device 104. The memory 302 includes any one of or a combination of volatile memory elements (e.g., RAM) and nonvolatile memory elements (e.g., read only memory (ROM), hard disk, tape, etc.).

The user interface 304 comprises the components with which a user interacts with the computing device 104, such as a keyboard and mouse, and a device that provides visual information to the user, such as a cathode ray tube (CRT) or liquid crystal display (LCD) monitor.

With further reference to FIG. 3, the one or more I/O devices 306 are configured to facilitate communications with the camera 102 as well as the other devices 116 and may include one or more communication components such as a modulator/demodulator (e.g., modem), USB connector, wireless (e.g., (RF)) transceiver, a telephonic interface, a bridge, or a router.

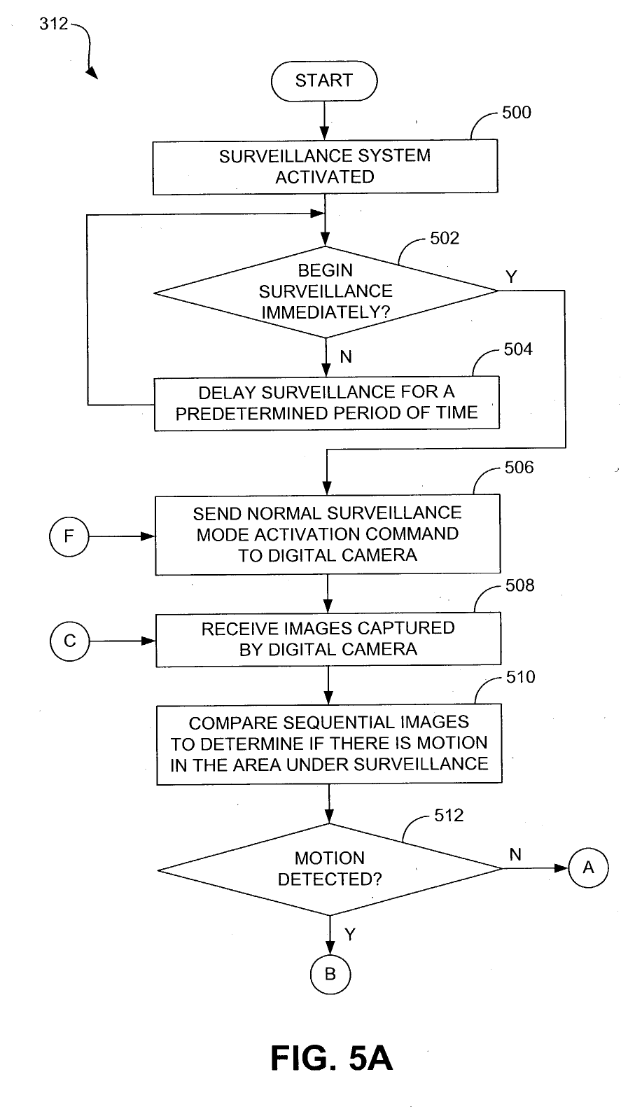

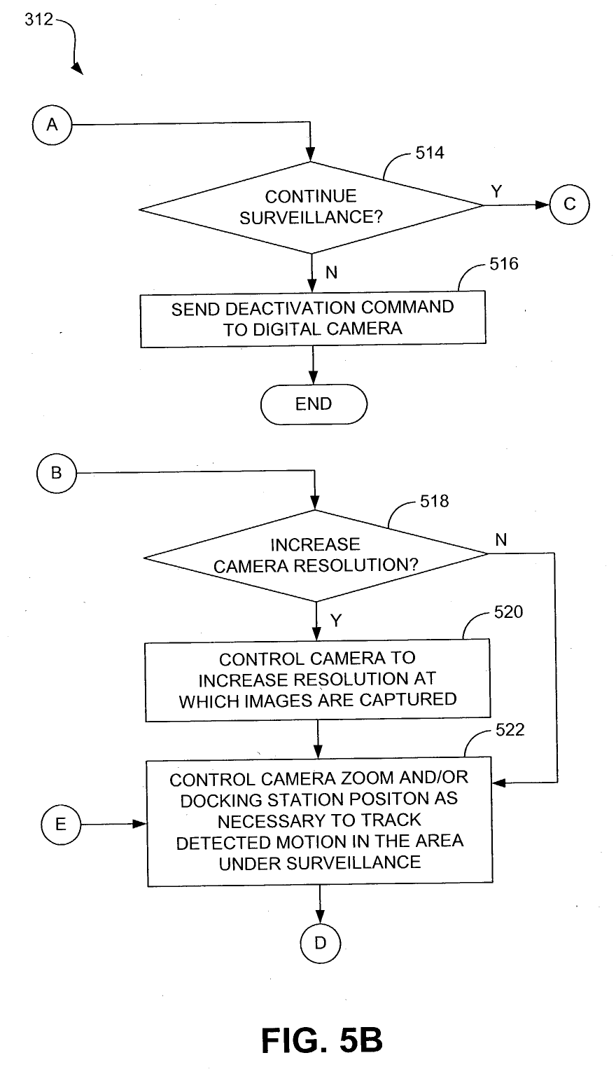

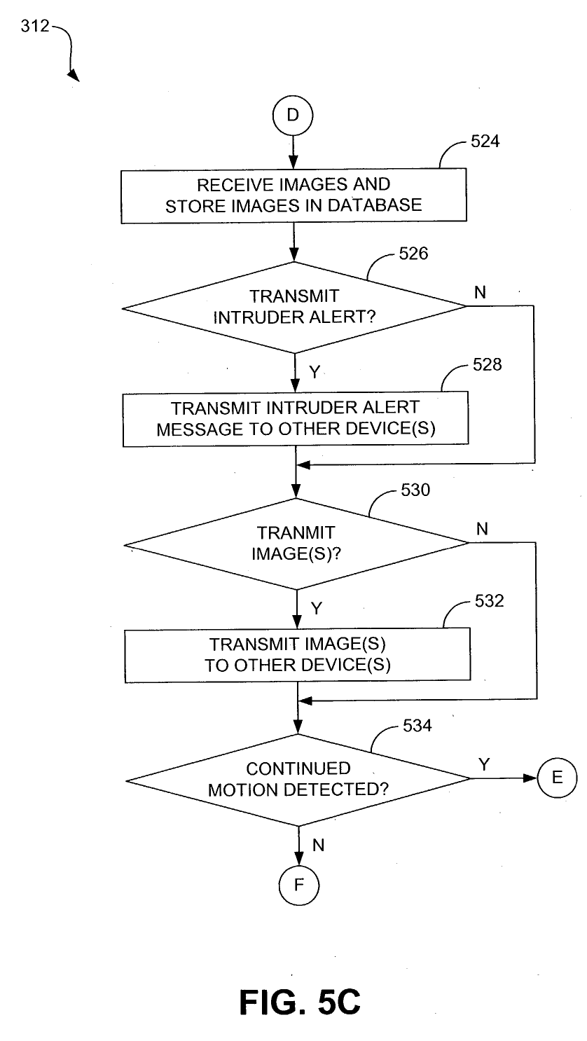

The memory 302 comprises various programs, for instance in software, including an operating system 310 and surveillance system 312. The operating system 310 controls the execution of other software and provides scheduling, input-output control, file and data management, memory management, and communication control and related services. As with the camera surveillance module 220 described above, the nature of the surveillance system 312 depends upon the mode in which it operates. More specifically, the surveillance system 220 may act in a control or managerial capacity in which it, at least to some degree, controls operation of the camera 102 and therefore the surveillance process, or may act in a relatively passive manner in which it simply stores data provided by the camera and/or transmits this data to other devices (e.g., devices 116). In the former case, the surveillance system 312 may comprise one or more motion detection algorithms 314 that are configured to analyze images captured by the camera 102 and determine whether an object is moving in the area under surveillance. Examples of operation of the surveillance system 312 in former case are described below in relation to FIGS. 5A and 5B.

In addition to the above-mentioned components, the memory 302 may comprise a database 316, for instance located on a hard disk, that is used to store data such as images captured by the digital camera 102.

Various programs have been described above. These programs can be stored on any computer-readable medium for use by or in connection with any computer-related system or method. In the context of this disclosure, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

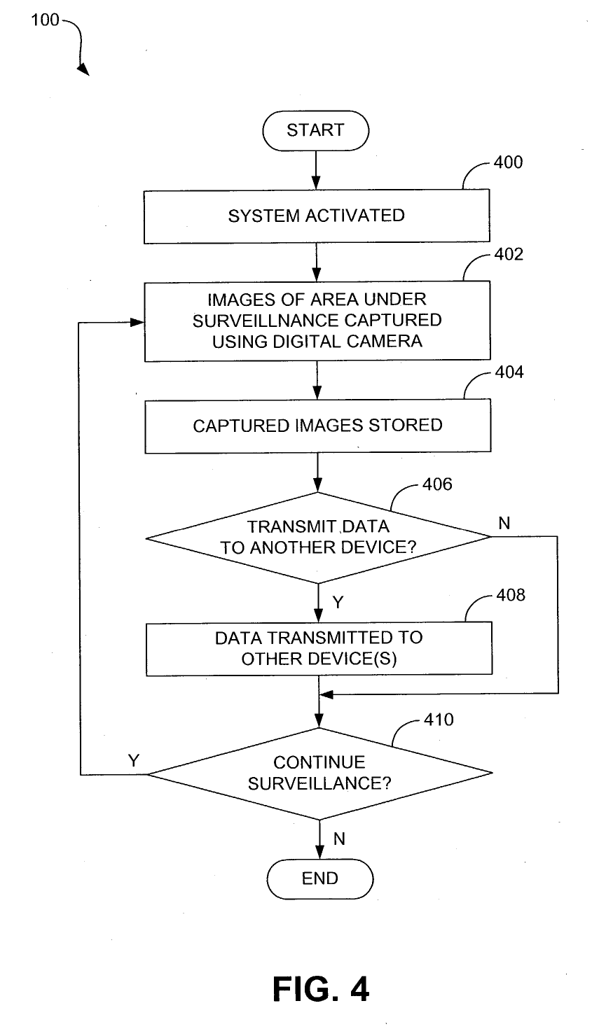

FIG. 4 is a flow diagram of a method for conducting surveillance on an area. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400, the system 100 is activated. This activation may occur in response to an affirmative action on the part of the user (e.g., initiation of an appropriate program on the user computing device 104). Alternatively activation may occur automatically in response to some other stimulus (e.g., detected motion within the area under surveillance). In either case, images of the area under surveillance are captured using the digital camera, as indicated in block 402. In some embodiments, relatively low resolution images (e.g., less than 1 megapixel each) are captured in rapid succession (e.g., multiple frames per second) such that the camera operates in a “movie” mode. In other embodiments, images (of either relatively low or high resolution (e.g., 1 or more megapixels each) are captured at a given periodicity (e.g., one image each second) to create a pictorial record of the happenings in the area under surveillance.

At some point during operation, images captured by the camera 102 are stored as indicated in block 404. In some embodiments, all captured images are stored such that all information collected by the camera is retained and is available for review. In other embodiments, images are only stored under certain, predefined circumstances. In the latter case, images may only be stored if, for example, motion in the area under surveillance is detected. Depending upon the mode of operation that is implemented, the motion detection analysis can be conducted by the camera 102, the user computing device 104, or a combination of the two. To ensure that this motion and the objects that are creating it is captured, the camera zoom and/or the docking station position may be adjusted. Irrespective of which images are stored, storage can comprise storage of images in camera memory (e.g., memory 224) and/or storage within the memory (e.g., hard disk) of the user computing device 104. In the latter case, the images to be stored are first sent from the camera 102 to the computing device 104. In situations in which the camera 102 is electrically connected to the docking station 106, the images may be routed to the computing device 104 via the docking station.

With reference next to decision block 406, it is determined whether data is to be transmitted to another device, for example one of the devices 116 shown in FIG. 1. If so, flow continues to block 408 at which the data is transmitted to one or more other devices. The data that is transmitted can comprise, for example, an intruder alert that alerts someone (e.g., a homeowner, a security company technician, law enforcement personnel) that there may be an intruder in the area under surveillance. In addition or exception, the data can comprise one or more images captured of the area under surveillance.

If no data was to be transmitted (block 406), or if any data to be transmitted has been transmitted (block 408), it is next determined whether surveillance is to be continued, as indicated in decision block 410. If so, flow returns to block 402 and continues in the manner described above. If surveillance is to be discontinued, however, flow for the session is terminated.

FIGS. 5-6 together provide a detailed example of operation of the system in providing surveillance of an area. More particularly, FIGS. 5A-5C provide an example of operation of the surveillance system 312 of the user computing device 104 in controlling operation of the digital camera 102; and FIGS. 6A-6B provide an example of operation of the camera surveillance module 220 in receiving the commands from the computing device surveillance system and performing the requested tasks.

Beginning with block 500 of FIG. 5A, the surveillance system 312 of the user computing device 104 is activated. This activation may occur, for example, in response to a user command entered using the user interface 304. Once the surveillance system 312 is activated, it is determined whether surveillance is to begin immediately, as indicated in decision block 502. In other words, it is determined whether surveillance is scheduled to begin at a later time. If surveillance is scheduled to begin later, the user may have designated a start time for the surveillance to begin (e.g., when the user is going to leave home). If surveillance is to begin immediately, flow continues down to block 506 described below. If surveillance is not to begin immediately, however, flow continues to block 504 at which surveillance is delayed for a predetermined period of time.

Once surveillance is to begin, the surveillance system 312 of the user computing device 104 sends a normal surveillance mode activation command to the digital camera 102, as indicated in block 506. By way of example, this command is sent to the camera 102 via its docking station 106. In alternative embodiments in which the docking station 106 is not used, however, the command can be transmitted to the camera 102 directly.

The activation command initiates operation of the digital camera so that it powers up (if not already powered) and prepares to capture images. With reference to block 600 of FIG. 6A, which illustrates operation of the camera surveillance module 220 of the digital camera 102, once the activation command is received, the camera survellance module is activated. In the embodiment of FIG. 6A, the camera 102 captures relatively low resolution images of the area under surveillance, as indicated in block 602. The capture of relatively low resolution images facilitates rapid transmission of multiple images to the user computing device 104. Although relatively low resolution images are described as being captured, higher resolution images can be captured, if desired. For instance, higher resolution images may be appropriate if a particularly high-speed connection exists between the camera 102 and the user computing device 104 and/or if relatively few images per unit time are to be sent to the user computing device.

Irrespective of the nature of the captured images, images are sent to the user computing device 104, as indicated in block 604. In some embodiments, all captured images are sent to the user computing device 104. In other embodiments, however, only selected images (e.g., only those in which motion is detected) are sent.

With reference back to FIG. 5A, and operation of the user computing device surveillance system 312, once images are sent by the digital camera 102, they are received, as indicated in block 508. Assuming that the camera 102 is not configured to make any motion detection determinations, sequential images received from the camera are then compared by the surveillance system 312, and more particularly using a motion detection algorithm 314, to determine if there is motion in the area under surveillance, as indicated in block 510. In particular, the pixels of the sequential images are compared with one another by the motion detection algorithm 314 to determine whether the differences between the pixels surpass a predetermined threshold over which a positive determination of motion is indicated. In such a case, inconsequential motion (e.g., movement of a tree branch seen through a window, movement of a pet through a room under surveillance, etc.) can be ignored by the system 100, so that only significant movement (e.g., movement of a human being) yields a positive motion determination.

Referring next to decision block 512, if motion is not detected, flow continues to decision block 514 of FIG. 5B at which it is determined whether surveillance is to be continued. If not, a deactivation command is sent to the digital camera 102 (block 516), and flow for the surveillance session is terminated. If, on the other hand, surveillance is to continue, flow returns to block 508 of FIG. 5A described above at which images (e.g., relatively low resolution images) are received from the camera 102.

If motion is detected (decision block 512), flow continues to decision block 518 of FIG. 5B at which it is determined whether to increase the resolution of the camera. This determination is made assuming that the digital camera 102 is, as described above, configured to capture relatively low resolution images in the normal surveillance mode. If no such resolution increase is to be had, flow continues down to block 522 described below. If, however, the camera resolution is to be increased, flow continues to block 520 at which the camera 102 is controlled, through an appropriate command sent to the camera (e.g., via the docking station 106), to increase the resolution at which images are captured.

Returning to FIG. 6A, and operation from the perspective of the digital camera 102, it is determined at decision block 606 whether a deactivation command is received from the user computing device 104. If so, flow for the camera surveillance module 220 for this surveillance session is terminated. If no such command is received, however, flow continues to decision block 608 at which it is determined whether a command to capture relatively high resolution images has been received. If not, it is presumed (in this embodiment) that no motion has been detected and there is no reason to capture higher resolution images. Accordingly, flow returns to block 602 at which relatively low resolution images of the area under surveillance are again captured.

If a command to increase image capture resolution is received at decision block 608, however, it is presumed (in this embodiment) that the surveillance system 312 of the user computing device 104 has detected motion in the area under surveillance. In such a case, flow continues to block 610 and the camera image capture resolution is increased.

Returning to FIG. 5B, the surveillance system 312 of the user computing device 104 next controls operation of the camera 102 and/or the docking station 106 on which the camera rests. Specifically, the system 312 controls the camera zoom and/or docking station positioning (rotation and/or tilting) so that the detected motion can be tracked as indicated in block 522. In such a case, close, high resolution images of the moving object (e.g., intruder) and what it is doing in the area under surveillance can be obtained.

With reference to FIG. 6B, it is determined by the camera surveillance module 220 whether such a zoom command is received, as indicated in decision block 612. If so, the camera surveillance module 220 adjusts the camera zoom as commanded by the user computing device 104, as indicated in block 614. Typically, such adjustment will result in zooming in on a given object in the area under surveillance. Next, with reference to block 616, images (e.g., relatively high resolution images) are captured and, as indicated in block 618, are sent to the user computing device 104.

Referring next to FIG. 5C, the images captured by the digital camera 102 are received and stored (e.g., in the database 316 on a hard disk) by the surveillance system 312, as indicated in block 524. At this point, the system 312 determines whether to transmit an intruder alert, as indicated in decision block 526. If so, an intruder alert message (e.g., text message) is transmitted to one or more other devices, as indicated in block 528. By way of example, this message can be transmitted to a portable device (mobile telephone, PDA, notebook computer) of the user, or a computer of a security company or law enforcement organization.

In addition or exception to the intruder alert message, one or more of the images captured by the digital camera 102 can also be transmitted. Accordingly, with reference to decision block 530, it is determined whether to transmit such an image. If yes, one or more images are transmitted to one or more other devices, as indicated in block 532. If no, flow continues down to decision block 534 at which it is determined whether motion continues within the area under surveillance. If such motion is detected, flow returns to block 522 of FIG. 5B at which the zoom of the camera 102 and/or positioning of the docking station 104 is/are controlled to track the motion, and flow continues in the manner described above. If the motion has ceased, however, flow returns to block 506 of FIG. 5A at which a normal surveillance mode activation command is again sent to the digital camera 102 to resume normal surveillance.

Returning again to FIG. 6B, the camera surveillance module 220 determines whether such a command is received, as indicated in decision block 620. If so, flow returns to block 602 of FIG. 6A and relatively low resolution images are again captured. If not, however, motion is presumably still being detected by the user computing device 104 and flow returns to decision block 612 at which the zoom of the camera 102 is controlled by the computing device.

FIGS. 7A and 7B provide a detailed example of operation of the camera surveillance module 220 in an embodiment in which the camera 102 acts in a stand-alone manner and therefore operates without input from the user computing device 104. Beginning with block 700 of FIG. 7A, the camera surveillance module 220 is activated. This activation may occur in response to the user placing the camera in a “surveillance” mode using the camera user interface 214. Once the surveillance module 220 is activated, relatively low resolution images of the area under surveillance are captured, as indicated in block 702. As these images are captured, sequential images are compared by a motion detection algorithm 222 of the surveillance module 220, to determine if motion is in the area under surveillance, as indicated in block 704. In particular, the pixels of the sequential images are compared with one another by the motion detection algorithm 222 to determine whether the differences between the pixels surpass a threshold over which a positive determination of motion is reached.

Referring next to decision block 706, if motion is not detected, flow continues to decision block 708 at which it is determined whether surveillance is to be continued. If not, flow for the surveillance session is terminated. If surveillance is to continue, however, flow returns to block 702 described above.

If, at decision block 706, motion is detected, flow continues down to block 710, and the camera image capture resolution is increased. Next, with reference to block 712 of FIG. 7B, the zoom of the camera 102 is adjusted so as to zoom on the moving object or objects. Such zooming may comprise optical zooming in which one or more lenses are axially displaced, or so-called “digital zooming” in which captured images are cropped and enlarged. In addition or exception to zooming, the camera surveillance module 220 controls (e.g., rotates and/or tilts) its docking station 106 so as to direct the lens of the camera 102 toward the object(s). Relatively high resolution images of the moving object(s) are then captured, as indicated in block 714. To preserve memory space, the captured images may be automatically cropped by the camera surveillance module 220 such that, as indicated in block 716, any extraneous information is excluded from the image(s).

Referring next to block 718, one or more images are stored in camera memory. Alternatively or in addition, the images can be sent to the user computing device 104 for storage. In any case, the images stored in camera memory (e.g., storage memory 224) normally are cropped, if applicable, and compressed so as to conserve memory space.

At this point, it is determined whether motion continues within the area under surveillance, as indicated in decision block 720. If such motion is detected, flow returns to block 712 at which the zoom of the camera 102 is adjusted as necessary to continue tracking the moving object(s). If the motion has ceased, however, flow returns to block 702 of FIG. 7A at which low resolution images are again captured and analyzed to detect motion.

Although not indicated in FIG. 7A or 7B, the camera surveillance module 220 can facilitate transmission of data (e.g., intruder alert messages, images) to other devices, such as the devices 116 shown in FIG. 1. In such a case, the data can be transmitted directly to the other devices, or via the user computing device 104, depending upon the system configuration that is being used.

What is claimed is:

1. A method for conducting surveillance of an area, comprising:
capturing images of the area under surveillance using a portable digital camera;
detecting motion occurring within the area under surveillance; and
storing images of the area under surveillance captured by the digital camera.

2. The method of claim 1, wherein capturing images of the area under surveillance comprises capturing images of the area under surveillance using a portable, consumer digital camera.

3. The method of claim 1, wherein capturing images comprises capturing relatively high resolution images when motion is detected.

4. The method of claim 1, wherein detecting motion comprises comparing sequential images captured by the portable digital camera to determine the degree to which pixels in an image changed.

5. The method of claim 4, wherein comparing sequential images comprises comparing sequential images using a motion detection algorithm of the portable digital camera.

6. The method of claim 1, wherein storing images comprises only storing images when motion is detected.

7. The method of claim 1, wherein storing images comprises storing images on a user computing device in communication with the portable digital camera.

8. The method of claim 1, wherein storing images comprises storing images on the portable digital camera.

9. The method of claim 8, further comprising cropping images before they are stored on the portable digital camera.

10. The method of claim 1, further comprising increasing an image capture resolution of the portable digital camera in response to motion detection such that relatively high resolution images are captured and stored when motion is detected.

11. The method of claim 1, further comprising tracking detected motion.

12. The method of claim 11, wherein tracking detected motion comprises adjusting zoom of the portable digital camera.

13. The method of claim 11, wherein tracking detected motion comprises moving the portable digital camera using a docking station on which the camera docks.

14. The method of claim 1, further comprising transmitting data to another device when motion is detected.

15. The method of claim 14, wherein transmitting data comprises transmitting an intruder alert to the device.

16. The method of claim 14, wherein transmitting data comprises transmitting an image to the device.

17. A surveillance system, comprising:
a portable digital camera; and
a camera docking station that is adapted to receive the portable digital camera, the docking station being configured to move the portable digital camera such that a lens of the camera can be pointed in different directions.

18. The system of claim 17, wherein the portable digital camera comprises a portable, consumer digital camera.

19. The system of claim 17, wherein the portable digital camera comprises a surveillance module that is configured to detect motion that occurs in an area under surveillance.

20. The system of claim 17, wherein the portable digital camera comprises a surveillance module that is configured to control movement of the camera docking station.

21. The system of claim 17, wherein the camera docking station comprises at least one actuator that moves the docking station so as to at least one of rotate and tilt the portable digital camera.

22. The system of claim 17, further comprising a user computing device in communication with the portable digital camera.

23. The system of claim 22, wherein the user computing device is in communication with the portable digital camera via the camera docking station.

24. The system of claim 22, wherein the user computing device comprises a surveillance system that is configured to detect motion that occurs in an area under surveillance by analyzing sequential images captured by the portable digital camera.

25. The system of claim 22, wherein surveillance system of the user computing device is configured to control operation of the portable digital camera and the camera docking station.

26. A portable digital camera, comprising:
a camera lens;
a processor; and
memory including a camera surveillance module that is configured to detect motion that occurs in an area under surveillance and to control movement of a camera docking station on which the camera docks so as to change the direction at which the camera lens points.

27. A camera docking station, comprising:
an interface that is configured to electrically connect the docking station to a digital camera that docks on the docking station; and
at least one actuator, the actuator being configured to move the docking station to change the direction in which a lens of the digital camera is pointed.
